(19) United States
(12) Patent Application Publication
(10) Pub. No.: US 2007/0178577 A1
(43) Pub. Date: Aug. 2, 2007

(54) Method for effecting the anaerobic biological decomposition of organsiloxanes

(75) Inventors: Anton Candussio, Munchen (DE); Manfred Amann, Odelzhausen (DE); Guenter Wich, Munchen (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 10/598,645

(22) PCT Filed: Mar. 10, 2005
(86) PCT No.: PCT/EP05/02546

§ 371 Date: Sep. 7, 2006

(30) Foreign Application Priority Data
Mar. 11, 2004 (DE) 10 2004 011 993.7

(51) Int. Cl. C12S 13/00; A62D 3/02

(52) U.S. Cl. 435/262; 435/262.5

(57) ABSTRACT

Biological decomposition of compounds containing Si-C bands such as PDMS takes place under substantially anaerobic conditions in the presence of an alternative electron acceptor.

The invention relates to the anaerobic decomposition of linear or cyclic polyorganosiloxanes such as, for example, polydimethylsiloxane (PDMS) or organo-functional siloxanes, organosilanes, in particular organosilanols, and fragments formed from these compounds via chemical depolymerization.

Annually, several 100 000 tons of polymers are produced on the basis of polydimethylsiloxane (PDMS), based on an —(Si—O—Si)— repeating unit. A large part of these siloxanes passes into the environment during or after the use (textile industry, laundry detergent, paper industry, cosmetics, construction, pharmacy, agrochemicals, petrochemicals etc.). Siloxanes are polymers which do not occur naturally. To date, also, no biological processes are known which form or cleave an Si—C bond between a silicon atom and the carbon atom of a methyl group. Methods for the biological decomposition of siloxanes in wastewaters, e.g. in municipal sewage treatment plants or in wastewater treatment facilities of the chemical industry, in soils, sediments, sludges or other environmental compartments are not known.

Gravier et al. (2003) summarize how siloxane polymers are chemically decomposed in the environment. No enrichment of the high-molecular-weight siloxanes occurs, but these are essentially decomposed by hydrolysis in aqueous or terrestrial habitats to form organosilanol-terminated oligomers. These organosilanols and low-molecular-weight PDMS fragments and also cyclic siloxanes evaporate into the atmosphere, where they are ultimately oxidized to silicate, CO₂ and water by the hydroxyl radicals present there.

A high-molecular-weight polyorganosiloxane is not water soluble. In aqueous systems or in wastewater, phase separation occurs. Polyorganosiloxane accumulates essentially on particulate constituents in the water or forms, owing to a specific weight <1.0 g/cm³, a siloxane film at the surface. Polyorganosiloxane, in sewage treatment plants, even if an aerobic biological state is present, is therefore neither destroyed nor decomposed, but ends virtually quantitatively in the solid phase of the sewage sludge. Studies of such sludges have shown that the high-molecular-weight siloxanes are there then depolymerized in on average 20-30 days (Gravier et al. 2003) and then as described pass into the atmosphere and are there oxidized.

Grasset and Palla (U.S. Pat. No. 6,020,184) have described that decomposition of polymeric siloxane can also take place in aqueous systems. For this, an aqueous polyorgano-siloxane suspension is admixed with a biologically utilizable cosubstrate such as glucose and inoculated with a fungus of the genus Phanaerochaete or Aspergillus and incubated aerobically. Under these conditions, even in aqueous systems, in 60 days, up to 80% of the polymeric PDMS has decomposed. It is known that the fungi used do not first completely oxidize glucose, but produce organic acids. At the corresponding pHs of 2.5-4.5, acidic hydrolysis of the PDMS to give low-molecular-weight constituents takes place. Direct biological decomposition of the PDMS is not described.

Volatile low-molecular-weight decomposition products of PDMS are principally finally oxidized in the atmosphere; although combined biological and chemical decomposition under aerobic conditions is described (Graiver et al. 2003), it is not of importance in practice, since the evaporation rate of volatile organosilicones is 2-20 times greater than the biological decomposition rate. Accumulation of low-molecular-weight organosilicones in soils and sediments which are close to the surface and well ventilated therefore does not take place, although in deeper sediment layers and non-ventilated soils, nevertheless, accumulation of such compounds can occur.

It is an object of the present invention to provide a method by which a material comprising silicon-carbon single bonds, preferably polyorganosiloxanes, such as, for example, PDMS or organofunctional siloxanes, or organosilanes, in particular organosilanols, or fragments formed by chemical depolymerization thereof can be biologically decomposed.

The object is achieved by a method which is characterized in that a mixture of a material comprising silicon-carbon single bonds and a microorganism population is incubated under anaerobic or microaerobic conditions with addition of an alternative electron acceptor.

The material comprising silicon-carbon single bonds is preferably a material comprising polyorganosiloxanes, organofunctional siloxanes, organosilanes or fragments formed from these compounds. Preferably, the material is a liquid or a solid.

The compounds which can preferably be decomposed by the inventive method are preferably compounds of the formulae (1 to 3)
HO(SiR₂O)ₚH (1)
where p≧1,
R₃SiO(SiR₂O)_{q}SiR₃ (2)
where q≧0,
(SiR₂O)ᵣ (3)
where r=3-10, or
a mixed polymer of units of the formulae HOR₂SiO_{1/2}, R₃SiO_{1/2}, R₂SiO, RSi(OH)O, RSiO_{3/2} and HOSiO_{3/2}, or an organosiloxane resin of units of the formula [R₃SiO_{1/2}] and [SiO_{4/2}], which further comprise additional Si-bound OH groups, R, R₂ and R₃ each being able to be identical or different and a monovalent, linear or cyclic, branched or unbranched, if appropriate substituted, hydrocarbon radical.

An alternative electron acceptor is taken to mean an electron acceptor except for oxygen. The alternative electron acceptor can be an organic compound or an inorganic compound. It serves to transfer the electrons taken up by the microorganism population in the oxidation of an Si—R bond (R being a monovalent organic radical, preferably a monovalent alkyl or aryl radical) and thus to enable the microorganism population to produce energy from substrate oxidation in the context of anaerobic respiration.

Organic alternative electron acceptors are, for example, fumarate or succinate. Inorganic alternative electron acceptors are, for example, oxidized iron ions, sulfate or nitrate. Preferably, for the inventive method, use is made of sulfate or nitrate, particularly preferably nitrate.

The alternative electron acceptor is present in the mixture preferably in a concentration of 0.1-100 mM. Particularly preferably, the electron acceptor is added in such a manner that it is present in a concentration of 1-100 mM.

Microaerobic conditions are taken to mean conditions in which less than 5% of free or dissolved oxygen is present in the mixture. Preference is given to conditions in which less than 1% of free or dissolved oxygen is present in the mixture. Particular preference is given to conditions in which less than 250 ppm of free or dissolved oxygen is present in the mixture.

Microaerobic or anaerobic conditions can be achieved, for example, by technical methods such as gas exchange or chemical consumption of residual oxygen. Preferably, microaerobic or anaerobic conditions are produced by oxygen present being consumed by the microorganism population present and the feed of further oxygen being suppressed. Particularly preferably, the microaerobic or anaerobic conditions are achieved by the inventive method being carried out in a closed vessel such as, for example, a digestion tower in a sewage treatment plant.

The microorganism population is preferably a population such as is present in sewage sludge or in a sewage treatment plant or in a soil sediment. Preferably, it is a microorganism population which grows under anaerobic conditions, particularly preferably displays optimal growth under these conditions.

In the inventive method, microorganism populations can be added externally, or microorganisms already present in the mixture (sewage sludge, soil etc.) can be used.

The inventive method, in contrast to the method disclosed in U.S. Pat. No. 6,020,184, does not require any further oxidizable substrates (cosubstrates) such as, for example, carbohydrates, for example glucose.

Preference is given to methods in which no oxidizable cosubstrates are added. Particular preference is given to those methods in which no cosubstrates are present in the batch and the batch therefore consists of said components.

The method is preferably carried out at a temperature of 20° C. to 80° C., more preferably at a temperature of 30° C. to 70° C., in particular preferably at a temperature of 40° C. to 60° C.

The incubation preferably proceeds over a period of 1 to 200 h, more preferably 10 to 150 h, in particular preferably 24 to 100 h.

The inventive method is suitable for decomposing polyorganosiloxanes such as, for example, PDMS or organofunctional siloxanes, and organosilanes, in particular organosilanols, continuously (i.e. with permanent inflow of new substrate and simultaneous discharge of decomposed products) or batchwise (i.e. in a batch without further inflow of new substrate).

In the inventive method, the polyorganosiloxanes or organosilanes can already have been prehydrolyzed upstream of the anaerobic decomposition by means of hydrolysis, e.g. by treatment with acid or base.

The inventive method functions, for example, in a sewage treatment plant, in sediments or in other aquatic or terrestrial compartments. For instance, the inventive method can be used, for example, in an anaerobic stage in a wastewater treatment plant, or it can be used to decompose polyorganosiloxane or organo-silane or fragments formed therefrom via chemical depolymerization present in terrestrial or aquatic low-oxygen or oxygen-free compartments.

The example hereinafter serves for further explanation of the invention.

### EXAMPLE 1

Decomposition of Dimethylsilanediol (DMSD)

Sewage sludge from a municipal sewage treatment plant was taken off from running operations under oxygen-free conditions (N₂-comprising sample vessels). To separate off interfering substrates, the cell mass was resuspended in 5-times the volume of an oxygen-free buffer (50 mmol/l of potassium phosphate pH 6.8) and centrifuged off. Oxygen-free solutions were produced by degassing the solution and purging with gaseous nitrogen.

The operation (resuspending/centrifuging) was repeated 3 times.

The washed oxygen-free cell mass was transferred in the absence of oxygen into shake flasks comprising culture medium (10 g of moist cell mass per 100 ml of medium). For control batches, the sewage sludge was autoclaved and inactivated thereby. Culturing proceeded in a minimal medium (SM1) without the addition of complex nutrients. The culture medium was composed as follows:

| Salt: | [g/l] |
|---|---|
| CaCl₂•2H₂O | 0.0147 |
| MgSO₄•7H₂O | 0.3 |
| KH₂PO₄ | 3.0 |
| K₂HPO₄ | 12.0 |
| (NH₄)₂SO₄ | 5.0 |
| NaCl | 0.1 |
| FeSO₄•7H₂O | 0.002 |
| Na₃-citrate•2H₂O | 1.0 |

| Trace elements: | [mg/l] |
|---|---|
| Na₂MO₄•2H₂O | 0.15 |
| CoCl₂•6H₂O | 0.7 |
| CuSO₄•5H₂O | 0.25 |
| MnCl₂•4H₂O | 1.6 |
| ZnSO₄•7H₂O | 0.3 |

As electron acceptor, in addition, 5 g/l of KNO₃ were added. As sole carbon source, finally dimethylsilane-diol (water-soluble; molar weight 92 g/l) was added to the medium. The concentration in the batches was 1 mmol/l. Culturing proceeded under anaerobic conditions on orbital shakers at a temperature of 30° C. The total culture time was 11 days. Samples of the culture medium were taken off at regular intervals and analyzed immediately. The samples were likewise taken off under anaerobic conditions (glove box, N₂ atmosphere) directly from the shake flasks.

Analysis: In experiments using DMSD as a substrate, the change in concentration of DMSD in the aqueous phase was determined by means of proton magnetic resonance spectroscopy (¹H-NMR). The intense signal at 0.164 ppm is very suitable here. Samples (0.9 ml) from the culture batches were taken off for this directly (via the stopper) from the vessel, admixed with standard (TSP in D₂O; TSP=3-(trimethylsilyl)propionic acid-D₄ sodium salt) and analyzed in the spectrometer. The DMSD signal can be quantified exactly via the known standard signal).

Result of the batches comprising DMSD (mg/l)

| | Incubation time (days) | | | | |
|---|---|---|---|---|---|
| | 0 | 2 | 4 | 7 | 11 |
| Batch | 90 | 85 | 73 | 64 | 55 |
| Sewage sludge | | | | | |
| DMSD (mg/l) | | | | | |
| Control batch | 87 | 87 | 86 | 83 | 79 |
| Inactivated sewage | | | | | |
| sludge | | | | | |
| DMSD (mg/l) | | | | | |

Compared with the control batch (−9% in 11 days), a marked decrease of the amount of DMSD was found in the anaerobically incubated batch comprising sewage sludge (−39% in 11 days).

### EXAMPLE 2

Decomposition of Octamethylcyclosiloxane (D₄)

The experiment was carried out in accordance with Example 1.

In each case five flasks were made up with sewage sludge and five flasks with inactivated sewage sludge. As carbon source, octamethylcyclosiloxane (D₄) was added to the medium. The siloxane is immiscible with water and first forms an oily film on the culture surface. With advancing culture time, the siloxane oil is emulsified in the culture. Relatively large cell aggregates form.

Culture proceeds in accordance with Example 1 in the mineral medium specified there (SM1) comprising 5 g/l of KNO₃ as electron acceptor. As sole carbon source, octamethylcyclosiloxane (D₄) was added to the batches (1 ml per 100 ml of medium). After differing incubation times, the D₄ content of the batches was determined.

Analysis of D₄

The entire batch was extracted 3 times with 50 ml of pentane, and to facilitate phase separation, it was centrifuged each time. The pentane phases were combined and D₄ determined quantitatively directly by means of gas chromatography (Hewlett Packard instrument hp5890_li). The gas-chromatographic determination proceeded using a 30 m capillary (Hewlett Packard HP-1 No. 59026323) using nitrogen as carrier gas. Temperature program: 50° C. (5 min)−270° C. at 20° C./min. Detection was by means of FID at 300° C. The resultant signal peaks were quantified using corresponding standard solutions.

Result of the batches comprising D₄ (ppm)

| | Incubation time (days) | | | | |
|---|---|---|---|---|---|
| | 0 | 2 | 4 | 7 | 11 |
| Batch | 7805 | 7050 | 6900 | 6732 | 6532 |
| Sewage sludge | | | | | |
| D₄ (ppm) | | | | | |
| Control batch | 8056 | 8010 | 7944 | 7770 | 7557 |
| Inactivated sewage | | | | | |
| sludge | | | | | |
| D₄ (ppm) | | | | | |

Compared with the control batch (−6.2% in 11 days) a marked decrease in the amount of D₄ was found in the anaerobically incubated batch comprising sewage sludge (−16.3% in 11 days).

1-8. (canceled)

9. A method for the biological decomposition of a material comprising a silicon-carbon single bond comprising incubating a mixture of the material and a microorganism population under anaerobic or microaerobic conditions with addition of an alternative electron acceptor.

10. The method of claim 9, wherein at least one material comprising a silicon-carbon single bond is a polyorganosiloxane, an organofunctional siloxane, an organo-silanol, or a fragment thereof.

11. The method of claim 9, wherein the alternative electron acceptor is selected from the group consisting of fumarate, succinate, oxidized iron ions, sulfate, or nitrate.

12. The method of claim 9, wherein the anaerobic or microaerobic conditions are selected such that less than 5% of free or dissolved oxygen is present.

13. The method of claim 12, wherein less than 1% of free or dissolved oxygen is present.

14. The method of claim 12, wherein less than 250 ppm, of free or dissolved oxygen is present.

15. The method of claim 9, wherein the alternative electron acceptor is present in a concentration of 0.1-100 mM.

16. The method of claim 9, wherein incubating takes place at a temperature of 20 to 80° C.

17. The method of claim 9, wherein incubating takes place at a temperature of 30 to 70° C.

18. The method of claim 9, wherein incubating takes place at a temperature of 40 to 60° C.

19. The method of claim 9, wherein incubating takes place over a period of 1 to 200 h.

20. The method of claim 9, wherein incubating takes place over a period of 10 to 150 h.

21. The method of claim 9, wherein incubating takes place over a period of 24 to 100 h.
